(19) United States
(12) Patent Application Publication
(10) Pub. No.: US 2026/0205898 A1
(43) Pub. Date: Jul. 16, 2026

(54) Updating Carrier Aggregation Configurations for Fragmented Carriers

(71) Applicant: Apple Inc., Cupertino, CA (US)

(72) Inventors: Xiang Chen, Palo Alto, CA (US); Yang Tang, San Jose, CA (US); Qiming Li, Beijing (CN); Jie Cui, San Jose, CA (US); Yuqin Chen, Beijing (CN); Dawei Zhang, Saratoga, CA (US); Manasa Raghavan, Sunnyvale, CA (US); Konstantinos Sarrigeorgidis, Los Gatos, CA (US); Haitong Sun, Saratoga, CA (US); Yuexia Song, Beijing (CN)

(21) Appl. No.: 19/136,794

(22) PCT Filed: Jun. 7, 2024
(86) PCT No.: PCT/CN2024/098044

§ 371 Date: Jun. 6, 2025

(51) Int. Cl. H04W 36/00

(52) U.S. Cl. CPC H04W 36/00692; H04W 36/0058

(57) ABSTRACT

This disclosure relates to techniques for updating carrier aggregation (CA) configurations for fragmented carriers in a wireless communication system. A user equipment (UE) can provide an indication to a network of a new supported CA configuration upon changing its radio frequency (RF) chain configuration. In addition, a UE can provide an indication to a network regarding applicability of a previously reported supported CA configuration upon changing its RF chain configuration. Further, a UE can signal a CA capability associated with a gap size between component carriers (CCs). In addition, a UE can switch between a single RF chain to multiple RF chains.

### FIELD

The present application relates to wireless communications, and more particularly to systems, apparatuses, and methods for updating carrier aggregation (CA) configurations for fragmented carriers in a wireless communication system.

### DESCRIPTION OF THE RELATED ART

Wireless communication systems are ubiquitous. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP 2 CDMA2000 (e.g., 1xRTT, 1xEV-DO, HRPD, eHRPD), IEEE 802.11 (WLAN or WiFi), BLUETOOTH™, etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for updating carrier aggregation (CA) configurations for fragmented carriers in a wireless communication system.

For example, in some embodiments, a wireless device (e.g., a baseband processor of a wireless device) can receive, from a network (e.g., from a base station of the network and/or a baseband processor of the base station), a CA configuration based, at least in part, on a reported CA capability, e.g., a CA capability previously transmitted to the network. In addition, the wireless device can be configured to determine, based on local conditions, to reconfigure an RF receive chain, e.g., an RF receive chain used to receive one or more component carriers (CCs) associated with the CA configuration, and transmit a request to update the CA capability, e.g., based, at least in part, on the determination.

As another example, in some embodiments, a wireless device (e.g., a baseband processor of a wireless device) can transmit to a network (e.g., from a base station of the network and/or a baseband processor of the base station), a capability report that includes a plurality of supported CA combinations, e.g., prior to receiving a CA configuration. The plurality of CA combinations can include at least a first set of CCs for a CA band combination that uses a single RF receive chain for receiving the first set of CCs and a second set of CCs for the CA band combination that uses separate RF receive chains for receiving the second set of CCs. In addition, the wireless device can be configured to perform RRM measurements, e.g., based on a gap between CCs of the CA configuration, and determine to reconfigure the RF receive chain based on the RRM measurements. The wireless device can be configured to transmit, to the network, an indication of a selected RF receive chain based on the determination to reconfigure the RF receive chain.

As a further example, in some embodiments, a wireless device (e.g., a baseband processor of a wireless device) can be configured to receive, from a network (e.g., from a base station of the network and/or a baseband processor of the base station), an indication that a network supports a CA capability indicating a spectrum span of receivable intra-band non-contiguous CA configurations, e.g., prior to the wireless device receiving a CA configuration from the network. In addition, the wireless device can be configured to transmit, to the network and responsive to the indication, a CA capability indicating one or more spectrum spans of intra-band non-contiguous CA configurations that can be received via a single RF receive chain and receive a CA configuration that is based, at least in part, on the one or more spectrum spans of intra-band non-contiguous CA configurations that can be received via a single RF receive chain.

As yet another example, in some embodiments, a wireless device (e.g., a baseband processor of a wireless device) can be configured to receive, from a network (e.g., from a base station of the network and/or a baseband processor of the base station), an indication that the network supports RF chain reconfiguration switching. The indication can be received prior to the wireless device receiving a CA configuration. In addition, the wireless device can be configured to transmit, to the network and based, at least in part on the indication, the CA capability. The CA capability can assume an intra-band non-contiguous CA configuration can be received using a single RF receive chain.

Note that the techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings.

FIG. 1 illustrates an exemplary (and simplified) wireless communication system, according to some embodiments.

FIG. 2 illustrates an exemplary base station in communication with an exemplary wireless user equipment (UE) device, according to some embodiments.

FIG. 3 illustrates an exemplary block diagram of a UE, according to some embodiments.

FIG. 4 illustrates an exemplary block diagram of a base station, according to some embodiments.

FIG. 5 is a block diagram illustrating an example modem or baseband processor, according to some embodiments.

FIG. 6 is a flowchart diagram illustrating an example of signaling for a UE to provide an indication to a network of a new supported CA configuration upon changing its radio frequency (RF) chain configuration, at least according to some embodiments.

FIG. 7 is a flowchart diagram illustrating an example of signaling for a UE to provide an indication to a network regarding applicability of a previously reported supported CA configuration upon changing its RF chain configuration, at least according to some embodiments.

FIG. 8 is a flowchart diagram illustrating an example of signaling for a UE to signal CA capability, at least according to some embodiments.

FIGS. 9 and 10 are flowchart diagrams illustrating examples of signaling to support a UE switching between a single RF chain and multiple RF chains, at least according to some embodiments.

FIG. 11 is a flowchart diagram illustrating an example of a method for a wireless device to provide an indication to a network of a new supported CA configuration upon changing its radio frequency (RF) chain configuration, at least according to some embodiments.

FIG. 12 is a flowchart diagram illustrating an example of a method for a wireless device to provide an indication to a network regarding applicability of a previously reported supported CA configuration upon changing its RF chain configuration, at least according to some embodiments.

FIG. 13 is a flowchart diagram illustrating an example of a method for a wireless device to signal a CA capability, at least according to some embodiments.

FIG. 14 is a flowchart diagram illustrating an example of a method for a wireless device to switch between a single RF chain and multiple RF chains, at least according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that can appear throughout the present disclosure are provided below:
UE: User Equipment
RF: Radio Frequency
BS: Base Station
LTE: Long Term Evolution
NR: New Radio
TX: Transmission/Transmit
RX: Reception/Receive
RAT: Radio Access Technology
TRP: Transmission-Reception-Point
DCI: Downlink Control Information
CORESET: Control Resource Set
QCL: Quasi-Co-Located or Quasi-Co-Location
CSI: Channel State Information
CQI: Channel Quality Indicator
PMI: Precoding Matrix Indicator
RI: Rank Indicator
CA: Carrier Aggregation

### Terms

The following is a glossary of terms that can appear in the present disclosure:

Memory Medium—Any of various types of non-transitory memory devices or storage devices. The term “memory medium” is intended to include any computer system memory or random-access memory, such as DRAM, DDR RAM, SRAM, EDO RAM, Rambus RAM, etc. ; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable, and that perform wireless communications. Examples of UE devices include mobile telephones or smart phones (e.g., iPhone™, Android™-based phones), tablet computers, portable gaming devices, wearable devices (e.g., smart watch, smart glasses), laptops, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or can be stationary or fixed at a certain location. A UE is an example of a wireless device.

Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station (BS) or Access Point (AP)—The term “Base Station” has the full breadth of its ordinary meaning, and at least includes a wireless communication station installed at a fixed location and used to communicate as part of a wireless telephone system or radio system. The term “access point” (or “AP”) is typically associated with WiFi-based communications and is used similarly.

Processing Element (or Processor)—refers to various elements or combinations of elements that are capable of performing a function in a device, e.g., in a communication device or in a network infrastructure device. Processing elements can include, for example: processors and associated memory, portions or circuits of individual processor cores, entire processor cores, processor arrays, circuits such as an ASIC (Application Specific Integrated Circuit), programmable hardware elements such as a field programmable gate array (FPGA), and/or larger portions of systems that include multiple processors, as well as any of various combinations of the above.

WiFi—The term “WiFi” has the full breadth of its ordinary meaning, and at least includes a wireless communication network or RAT that is serviced by wireless LAN (WLAN) access points and which provides connectivity through these access points to the Internet. Most modern WiFi networks (or WLAN networks) are based on IEEE 802.11 standards and are marketed under the name “WiFi”. A WiFi (WLAN) network is different from a cellular network.

Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

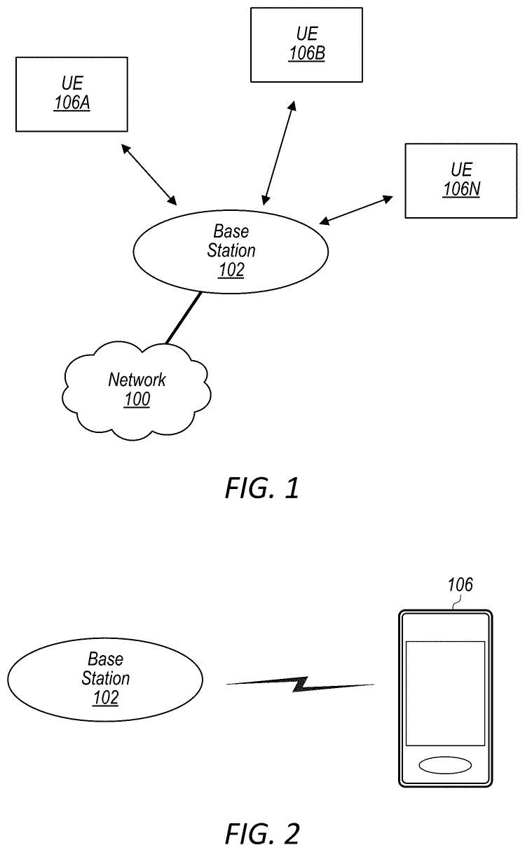

### FIGS. 1 and 2—Exemplary Communication System

FIG. 1 illustrates an exemplary (and simplified) wireless communication system in which aspects of this disclosure can be implemented, according to some embodiments. It is noted that the system of FIG. 1 is merely one example of a possible system, and embodiments can be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices can be referred to herein as a “user equipment” (UE) or UE device. Thus, the user devices 106 are referred to as UEs or UE devices.

The base station 102 can be a base transceiver station (BTS) or cell site, and can include hardware and/or software that enables wireless communication with the UEs 106A through 106N. If the base station 102 is implemented in the context of LTE, it can alternately be referred to as an ‘eNodeB’ or ‘eNB’. If the base station 102 is implemented in the context of 5G NR, it can alternately be referred to as a ‘gNodeB’ or ‘gNB’. The base station 102 can also be equipped to communicate with a network 100 (e.g., a core network of a cellular service provider, a telecommunication network such as a public switched telephone network (PSTN), and/or the Internet, among various possibilities). Thus, the base station 102 can facilitate communication among the user devices and/or between the user devices and the network 100. The communication area (or coverage area) of the base station can be referred to as a “cell.” As also used herein, from the perspective of UEs, a base station can sometimes be considered as representing the network insofar as uplink and downlink communications of the UE are concerned. Thus, a UE communicating with one or more base stations in the network can also be interpreted as the UE communicating with the network.

Note that, at least in some 3GPP NR contexts, base station (gNB) functionality can be split between a centralized unit (CU) and a distributed unit (DU). The illustrated base station 102 can support the functionality of either or both of a CU or a DU, in such a network deployment context, at least according to some embodiments. In some instances, the base station 102 can be configured to act as an integrated access and backhaul (IAB) donor (e.g., including IAB donor CU and/or IAB donor DU functionality). In some instances, the base station 102 can be configured to act as an IAB node (e.g., including IAB mobile termination (MT) and IAB-DU functionality). Other implementations are also possible.

The base station 102 and the user devices can be configured to communicate over the transmission medium using any of various radio access technologies (RATs), also referred to as wireless communication technologies, or telecommunication standards, such as LTE, LTE-Advanced (LTE-A), LAA/LTE-U, 5G NR, WiFi, etc.

Base station 102 and other similar base stations operating according to the same or a different cellular communication standard can thus be provided as one or more networks of cells, which can provide continuous or nearly continuous overlapping service to UE 106 and similar devices over a geographic area via one or more cellular communication standards.

Note that a UE 106 can be capable of communicating using multiple wireless communication standards. For example, a UE 106 might be configured to communicate using multiple 3GPP cellular communication standards. In some embodiments, the UE 106 can be configured to perform techniques for updating CA configurations for fragmented carriers in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 can be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 can include a processor (processing element) that is configured to execute program instructions stored in memory. The UE 106 can perform any of the method embodiments described herein, such as supporting CA configurations for non-contiguous CCs as described herein, by executing such stored instructions. Alternatively, or in addition, the UE 106 can include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 can be configured to communicate using any of multiple wireless communication protocols. For example, the UE 106 can be configured to communicate using two or more of LTE, LTE-A, 5G NR, WiFi, BLUETOOTH™, or GNSS. Other combinations of wireless communication standards are also possible.

The UE 106 can include one or more antennas for communicating using one or more wireless communication protocols according to one or more RAT standards. In some embodiments, the UE 106 can share one or more parts of a receive chain and/or transmit chain between multiple wireless communication standards. The shared radio can include a single antenna, or can include multiple antennas (e.g., for multiple-input, multiple-output or “MIMO”) for performing wireless communications. In general, a radio can include any combination of a baseband processor, analog RF signal processing circuitry (e.g., including filters, mixers, oscillators, amplifiers, etc.), or digital processing circuitry (e.g., for digital modulation as well as other digital processing). Similarly, the radio can implement one or more receive and transmit chains using the aforementioned hardware. For example, the UE 106 can share one or more parts of a receive and/or transmit chain between multiple wireless communication technologies, such as those discussed above.

In some embodiments, the UE 106 can include any number of antennas and can be configured to use the antennas to transmit and/or receive directional wireless signals (e.g., beams). Similarly, the BS 102 can also include any number of antennas and can be configured to use the antennas to transmit and/or receive directional wireless signals (e.g., beams). To receive and/or transmit such directional signals, the antennas of the UE 106 and/or BS 102 can be configured to apply different “weight” to different antennas. The process of applying these different weights can be referred to as “precoding”.

In some embodiments, the UE 106 can include separate transmit and/or receive chains (e.g., including separate antennas and other radio components) for each wireless communication protocol with which it is configured to communicate. As a further possibility, the UE 106 can include one or more radios that are shared between multiple wireless communication protocols, and one or more radios that are used exclusively by a single wireless communication protocol. For example, the UE 106 can include a shared radio for communicating using either of LTE or NR, and separate radios for communicating using each of WiFi and BLUETOOTH™. Other configurations are also possible.

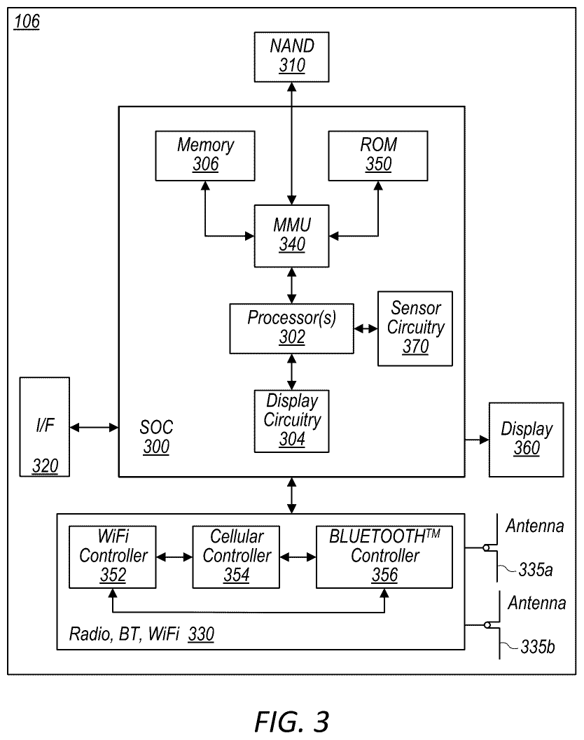

### FIG. 3—Block Diagram of an Exemplary UE Device

FIG. 3 illustrates a block diagram of an exemplary UE 106, according to some embodiments. As shown, the UE 106 can include a system on chip (SOC) 300, which can include portions for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

As shown, the SOC 300 can include processor(s) 302 which can execute program instructions for the UE 106 and display circuitry 304 which can perform graphics processing and provide display signals to the display 360. The SOC 300 can also include sensor circuitry 370, which can include components for sensing or measuring any of a variety of possible characteristics or parameters of the UE 106. For example, the sensor circuitry 370 can include motion sensing circuitry configured to detect motion of the UE 106, for example using a gyroscope, accelerometer, and/or any of various other motion sensing components. As another possibility, the sensor circuitry 370 can include one or more temperature sensing components, for example for measuring the temperature of each of one or more antenna panels and/or other components of the UE 106. Any of various other possible types of sensor circuitry can also or alternatively be included in UE 106, as desired. The processor(s) 302 can also be coupled to memory management unit (MMU) 340, which can be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 can be configured to perform memory protection and page table translation or set up. In some embodiments, the MMU 340 can be included as a portion of the processor(s) 302.

As shown, the SOC 300 can be coupled to various other circuits of the UE 106. For example, the UE 106 can include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, WiFi, GPS, etc.). The UE device 106 can include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 can include fewer or more antennas. Overall, the one or more antennas are collectively referred to as antenna 335. For example, the UE device 106 can use antenna 335 to perform the wireless communication with the aid of radio circuitry 330. The communication circuitry can include multiple receive chains and/or multiple transmit chains for receiving and/or transmitting multiple spatial streams, such as in a multiple-input multiple output (MIMO) configuration. As noted above, the UE can be configured to communicate wirelessly using multiple wireless communication standards in some embodiments.

The UE 106 can include hardware and software components for implementing methods for the UE 106 to perform techniques for updating CA configurations for fragmented carriers in a wireless communication system, such as described further subsequently herein. The processor(s) 302 of the UE device 106 can be configured to implement part or all of the methods described herein, e.g., by executing program instructions stored on a memory medium (e.g., a non-transitory computer-readable memory medium). In other embodiments, processor(s) 302 can be configured as a programmable hardware element, such as an FPGA (Field Programmable Gate Array), or as an ASIC (Application Specific Integrated Circuit). Furthermore, processor(s) 302 can be coupled to and/or can interoperate with other components as shown in FIG. 3, to perform techniques for updating CA configurations for fragmented carriers in a wireless communication system according to various embodiments disclosed herein. Processor(s) 302 can also implement various other applications and/or end-user applications running on UE 106.

In some embodiments, radio 330 can include separate controllers dedicated to controlling communications for various respective RAT standards. For example, as shown in FIG. 3, radio 330 can include a WiFi controller 352 and a cellular controller (e.g., LTE and/or LTE-A controller) 354, and in at least some embodiments, one or more or all of these controllers can be implemented as respective integrated circuits (ICs or chips, for short) in communication with each other and with SOC 300 (and more specifically with processor(s) 302). For example, WiFi controller 352 can communicate with cellular controller 354 over a cell-ISM link or WCI interface. While two separate controllers are illustrated within radio 330, other embodiments have fewer or more similar controllers for various different RATs that can be implemented in UE device 106.

Further, embodiments in which controllers can implement functionality associated with multiple radio access technologies are also envisioned. For example, according to some embodiments, the cellular controller 354 can, in addition to hardware and/or software components for performing cellular communication, include hardware and/or software components for performing one or more activities associated with WiFi, such as WiFi preamble detection, and/or generation and transmission of WiFi physical layer preamble signals.

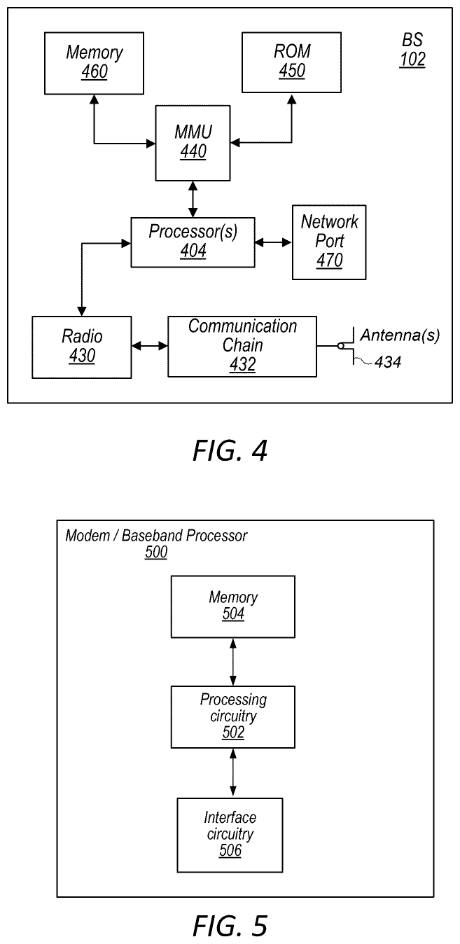

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 can include processor(s) 404 which can execute program instructions for the base station 102. The processor(s) 404 can also be coupled to memory management unit (MMU) 440, which can be configured to receive addresses from the processor(s) 404 and translate those addresses to locations in memory (e.g., memory 460 and read only memory (ROM) 450) or to other circuits or devices.

The base station 102 can include at least one network port 470. The network port 470 can be configured to couple to a telephone network and provide a plurality of devices, such as UE devices 106, access to the telephone network as described above in FIGS. 1 and 2. The network port 470 (or an additional network port) can also or alternatively be configured to couple to a cellular network, e.g., a core network of a cellular service provider. The core network can provide mobility related services and/or other services to a plurality of devices, such as UE devices 106. In some cases, the network port 470 can couple to a telephone network via the core network, and/or the core network can provide a telephone network (e.g., among other UE devices serviced by the cellular service provider).

In some embodiments, base station 102 can be a next generation base station, e.g., a 5G New Radio (5G NR) base station, or “gNB”. In such embodiments, base station 102 can be connected to a legacy evolved packet core (EPC) network and/or to a NR core (NRC) network. In addition, base station 102 can be considered a 5G NR cell and can include one or more transmission and reception points (TRPs). In addition, a UE capable of operating according to 5G NR can be connected to one or more TRPs within one or more gNBs.

The base station 102 can include at least one antenna 434, and possibly multiple antennas. The antenna(s) 434 can be configured to operate as a wireless transceiver and can be further configured to communicate with UE devices 106 via radio 430. The antenna(s) 434 communicates with the radio 430 via communication chain 432. Communication chain 432 can be a receive chain, a transmit chain or both. The radio 430 can be designed to communicate via various wireless telecommunication standards, including, but not limited to, 5G NR, 5G NR SAT, LTE, LTE-A, WiFi, etc.

The base station 102 can be configured to communicate wirelessly using multiple wireless communication standards. In some instances, the base station 102 can include multiple radios, which can enable the base station 102 to communicate according to multiple wireless communication technologies. For example, as one possibility, the base station 102 can include an LTE radio for performing communication according to LTE as well as a 5G NR radio for performing communication according to 5G NR. In such a case, the base station 102 can be capable of operating as both an LTE base station and a 5G NR base station. As another possibility, the base station 102 can include a multi-mode radio which is capable of performing communications according to any of multiple wireless communication technologies (e.g., 5G NR and WiFi, 5G NR SAT and WiFi, LTE and WiFi, etc.).

As described further subsequently herein, the BS 102 can include hardware and software components for implementing or supporting implementation of features described herein. The processor 404 of the base station 102 can be configured to implement and/or support implementation of part or all of the methods described herein, e.g., by executing program instructions stored on a memory medium (e.g., a non-transitory computer-readable memory medium). Alternatively, the processor 404 can be configured as a programmable hardware element, such as an FPGA (Field Programmable Gate Array), or as an ASIC (Application Specific Integrated Circuit), or a combination thereof. In the case of certain RATs, for example WiFi, base station 102 can be designed as an access point (AP), in which case network port 470 can be implemented to provide access to a wide area network and/or local area network(s), e.g., it can include at least one Ethernet port, and radio 430 can be designed to communicate according to the WiFi standard.

In addition, as described herein, processor(s) 404 can include one or more processing elements. Thus, processor(s) 404 can include one or more integrated circuits (ICs) that are configured to perform the functions of processor(s) 404. In addition, each integrated circuit can include circuitry (e.g., first circuitry, second circuitry, etc.) configured to perform the functions of processor(s) 404.

Further, as described herein, radio 430 can include one or more processing elements. Thus, radio 430 can include one or more integrated circuits (ICs) that are configured to perform the functions of radio 430. In addition, each integrated circuit can include circuitry (e.g., first circuitry, second circuitry, etc.) configured to perform the functions of radio 430.

### FIG. 5—Block Diagram of a Modem or Baseband Processor

FIG. 5 illustrates an example block diagram of a baseband processor 500, which can also be referred to as modem 500. The baseband processor 500 can provide signal processing functionality for one or more wireless communication technologies, such as WiFi and/or a cellular (e.g., 3GPP) communication technology and/or other wireless communication technologies. Thus, as one possibility, baseband processor 500 can represent a WiFi modem or WiFi controller; for example, the baseband processor 500 illustrated in FIG. 5 can represent one possible example of WiFi controller 352 illustrated in FIG. 3. As another possibility, baseband processor 500 can represent a cellular modem (or cellular controller) or cellular baseband processor; for example, the baseband processor 500 illustrated in FIG. 5 can represent one possible example of cellular controller 354 illustrated in FIG. 3. In some instances, the baseband processor 500 could implement functionality for supporting communication according to multiple wireless communication technologies. At least in some instances, the baseband processor 500 can run a real-time operating system, e.g., for facilitating performance of timing-dependent wireless communication functionality.

In some instances, the baseband processor 500 can be configured to support carrier aggregation (CA) configurations for fragmented carriers (e.g., non-contiguous component carriers (CCs)). For example, as further described herein, baseband processor 500 can be configured to provide an indication to a network of a new supported CA configuration upon changing its radio frequency (RF) chain configuration, provide an indication to a network regarding applicability of a previously reported supported CA configuration upon changing its RF chain configuration, signal a CA capability, and switch between a single RF chain to multiple RF chains.

The baseband processor 500 can include processing circuitry 502, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the baseband processor 500, such as physical layer (PHY) functionality, media access control (MAC) functionality, logical link control (LLC) functionality, radio resource control (RRC) functionality, radio link control (RLC) functionality, etc. In some instances, the baseband processor 500 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The baseband processor 500 can also include memory 504, which can include a non-transitory computer-readable memory medium. The memory 504 can include program instructions for performing signal processing and/or any of various possible general processing functions. The processing circuitry 502 can be capable of executing the program instructions stored in the memory 504. The memory 504 can also store data generated and/or used during processing performed by the processing circuitry 502.

As shown, the baseband processor 500 can further include interface circuitry, e.g., for communicating with other components of a wireless device (such as UE 106 and/or base station 102 illustrated in FIGS. 1-4), such as an application processor, radio/transceiver circuitry, and/or any of various other components. Such interfaces can be implemented in any of various ways; for example, as one possibility, the baseband processor 500 can have a direct interface with transceiver circuitry of a wireless device and can have an additional indirect interface with an application processor and/or other components of the wireless device by way of a system bus. Other configurations are also possible.

In at least some instances, the hardware and software components of the baseband processor 500 can be configured to implement or support implementation of features described herein, such as supporting CA configurations for fragmented carriers (e.g., non-contiguous CCs), among various other possible features. For example, the processing circuitry 502 of the baseband processor 500 can be configured to implement, or support implementation of, part or all of the methods described herein, e.g., by executing program instructions stored on memory (e.g., non-transitory computer-readable memory medium) 504 and/or using dedicated hardware components.

### Updating CA Configurations for Fragmented Carriers

According to some current cellular communication technologies, a user equipment device (UE) can report its carrier aggregation (CA) capability to a network when the UE initially attaches to the network. In response, the network can configure the UE with a CA configuration. At that point, the CA capability becomes static, meaning that once the UE reports its CA capability to the network, there is no way for the UE to change or update its CA capability unless the network initiates a UE capability enquiry. In other words, the UE cannot request a new CA configuration if and/or when conditions at the UE change. For example, a UE's radio frequency (RF) receive chain configuration can change depending on network RF requirements and, as a result, a number of component carriers (CCs) the UE can support can also change. In particular, in a case in which downlink carriers are fragmented, e.g., in which CCs are non-contiguous within a CA combination, it could be advantageous for a UE to reduce a number of receive chains needed for a single downlink band of 100 megahertz (MHz) or less that contains two non-contiguous CCs within a CA combination for an inter-operator co-located scenario. Therefore, improvements are desired.

Embodiments described herein provide systems, methods, and mechanisms for a UE to update its CA capability, e.g., such as in fragmented carrier situations. In particular, embodiments described herein provide signaling solutions for a UE to provide an indication to a network of a new supported CA configuration upon changing its radio frequency (RF) chain configuration, for a UE to provide an indication to a network regarding applicability of a previously reported supported CA configuration upon changing its RF chain configuration, for a UE to signal a CA capability, as well as signaling solutions to support a UE switching between a single RF chain to multiple RF chains. For example, based on field conditions (e.g., such as an amount of interference in a gap between CCs), a UE can reconfigure its RF chains and provide an indication to a network that triggers the network to initiate a UE capability enquiry. As another example, upon attachment, a UE can report multiple supported CA combinations as its CA capability and then indicate, e.g., based on field conditions/medium conditions (e.g., such as an amount of interference in a gap between CCs), which CA combination it is currently using via higher layer signaling. As a further example, a UE can determine its field conditions based on a network indication and/or UE measurements. As yet another example, a UE can indicate a spectrum span (and/or equivalent spectrum gap) of intra-band non-contiguous CA combinations it can support with a single RF chain. As a yet further example, a UE can determine when to switch between a single RF chain to multiple RF chains based on channel quality, e.g., the UE can provide interference measurements to a network and receive instructions to switch and/or the UE can request the switch based on the interference measurements.

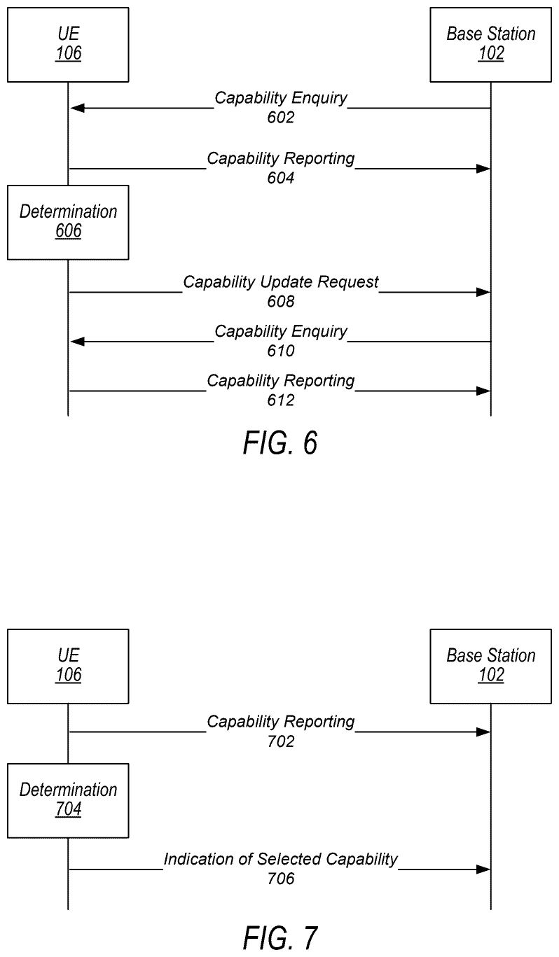

FIG. 6 is a flowchart diagram illustrating an example of signaling for a UE to provide an indication to a network of a new supported CA configuration upon changing its radio frequency (RF) chain configuration, at least according to some embodiments.

Aspects of the signaling of FIG. 6 can be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (such as baseband processor 500 illustrated in and described with respect to FIG. 5) and/or other hardware of such a device can be configured to cause the device to perform any combination of the illustrated signaling and/or other signaling.

Note that while at least some signaling of FIG. 6 are described in a manner relating to the use of communication techniques and/or features associated with 3GPP and/or NR specification documents, such description is not intended to be limiting to the disclosure, and aspects of the signaling of FIG. 6 can be used in any suitable wireless communication system, as desired. In various embodiments, some of the signaling shown can be performed concurrently, in a different order than shown, can be substituted for by one or more other signals, and/or can be omitted. Additional signaling can also be performed as desired. As shown, the signaling of FIG. 6 can operate as follows.

The signaling can begin with the wireless device (e.g., UE 106 and/or a baseband processor of UE, such as baseband processor 500) receiving, from a network (e.g., from a base station of the network, such as base station 102 and/or a baseband processor of the base station, such as baseband processor 500), a capability enquiry 602. The capability enquiry 602 can be received when the wireless device initially attaches to the network. In response, the wireless device can send/report its carrier aggregation (CA) capability to the network via capability reporting 604. The CA capability can indicate its current CA configuration, e.g., a number of component carriers (CCs) the wireless device can support in a downlink frequency band.

At 606, the wireless device can determine to reconfigure its radio frequency (RF) chains (e.g., how many receive chains it uses to receive CCs in the downlink frequency band), e.g., when certain conditions are met. In response to determining to reconfigure its RF chains, the wireless device can send a capability update request 608 to the network. The capability update request 608 can be an indication sent via a UE Assistance Information (UAI) message, a radio resource control (RRC) message, and/or a medium access control (MAC) control element (CE).

For example, the wireless device can perform radio resource management (RRM) measurements to determine a level of interference in a gap between non-contiguous CCs within the downlink frequency band. Further, based on the level of interference, the wireless device can then determine to reconfigure its RF chains.

As another example, in at least some instances, when configuring inter-band and/or intra-band non-contiguous CAs to the wireless device, the network can, as part of an RRC reconfiguration, directly or explicitly indicate that the wireless device can use a single (e.g., common) RF chain to receive non-contiguous CCs in a band. In such instances, the network can configure the wireless device to perform RRM measurements of interference in a gap between non-contiguous CCs within the downlink frequency band. The indication can be carried via a system information block (SIB) or via dedicated signaling to the wireless device. Thus, in at least some instances, the RRM measurements at 606 can be performed using the network provided configuration.

As a further example, in at least some instances, when configuring inter-band and/or intra-band non-contiguous CAs to the wireless device, the network can, as part of an RRC reconfiguration, indicate that the non-contiguous CCs in a band are an inter-operator collocated deployment. In such instances, the wireless device can then determine and/or decide whether it can use a single (common) RF chain. In such instances, the network can configure the wireless device to perform the RRM measurements of interference in a gap between non-contiguous CCs within the downlink frequency band. The indication can be carried via a system information block (SIB) or via dedicated signaling to the wireless device. Thus, in at least some instances, the RRM measurements at 606 can be performed using the network provided configuration.

As yet a further example, in at least some instances, the network can configure the wireless device to perform RRM measurements of the interference gap. In such instances, the wireless device can then determine whether it can use a single (common) RF chain.

Based on receipt of the capability update request 608, the network can send (and the wireless device can receive) capability enquiry 610. The capability enquiry 640 can be a filtered capability enquiry so the wireless device can provide updated CA capabilities, e.g., CA configurations the wireless device can support with the reconfigured RF chains. In response, the wireless device can send capability reporting 612 that can include the wireless device's CA configuration given the reconfigured RF chains. Note that based on the capability reporting 612, the network can configure new CA configurations (e.g., frequency bands and/or a number of CCs) for the wireless device. These new CA configurations can then be sent to the wireless device (and received by the wireless device).

FIG. 7 is a flowchart diagram illustrating an example of signaling for a UE to provide an indication to a network regarding applicability of a previously reported supported CA configuration upon changing its RF chain configuration, at least according to some embodiments.

Aspects of the signaling of FIG. 7 can be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (such as baseband processor 500 illustrated in and described with respect to FIG. 5) and/or other hardware of such a device can be configured to cause the device to perform any combination of the illustrated signaling and/or other signaling.

Note that while at least some signaling of FIG. 7 are described in a manner relating to the use of communication techniques and/or features associated with 3GPP and/or NR specification documents, such description is not intended to be limiting to the disclosure, and aspects of the signaling of FIG. 7 can be used in any suitable wireless communication system, as desired. In various embodiments, some of the signaling shown can be performed concurrently, in a different order than shown, can be substituted for by one or more other signals, and/or can be omitted. Additional signaling can also be performed as desired. As shown, the signaling of FIG. 7 can operate as follows.

The signaling can begin with the wireless device (e.g., UE 106 and/or a baseband processor of UE, such as baseband processor 500) sending, to a network (e.g., from a base station of the network, such as base station 102 and/or a baseband processor of the base station, such as baseband processor 500), capability reporting 702. Note that the capability reporting 702 can be sent in response to the wireless device receiving a capability enquiry, e.g., upon attachment to the network and/or upon sending a capability update request. The capability reporting 702 can include a plurality of CA combinations supported by the wireless device. For example, the wireless device can report a first set of CCs for a CA band combination when the wireless device uses a common RF chain and a second set of CCs for CA band combinations when the wireless device uses separate RF chains. In such an example, the first set of CCs can include more CCs than the second set of CCs.

At 704, the wireless device can determine to reconfigure its radio frequency (RF) chains (e.g., how many receive chains it uses to receive CCs in the downlink frequency band), e.g., when certain conditions are met. In response to determining to reconfigure its RF chains, the wireless device can send an indication of a selected capability message 706 to the network. The indication can be sent via a an RRC message and/or a MAC CE. Further, the indication can indicate whether the wireless device is using a common RF chain or separate RF chains, e.g., whether the wireless device can support more or less CCs. Note that based on the indication, the network can configure new CA configurations (e.g., frequency bands and/or a number of CCs) for the wireless device. These new CA configurations can then be sent to the wireless device (and received by the wireless device).

For example, the wireless device can perform RRM measurements to determine a level of interference in a gap between non-contiguous CCs within the downlink frequency band. Further, based on the level of interference, the wireless device can then determine to reconfigure its RF chains.

As another example, in at least some instances, when configuring inter-band and/or intra-band non-contiguous CAs to the wireless device, the network can, as part of an RRC reconfiguration, directly or explicitly indicate that the wireless device can use a single (e.g., common) RF chain to receive non-contiguous CCs in a band. In such instances, the network can configure the wireless device to perform RRM measurements of interference in a gap between non-contiguous CCs within the downlink frequency band. The indication can be carried via a system information block (SIB) or via dedicated signaling to the wireless device. Thus, in at least some instances, the RRM measurements at 704 can be performed using the network provided configuration.

As a further example, in at least some instances, when configuring inter-band and/or intra-band non-contiguous CAs to the wireless device, the network can, as part of an RRC reconfiguration, indicate that the non-contiguous CCs in a band are an inter-operator collocated deployment. In such instances, the wireless device can then determine and/or decide whether it can use a single (common) RF chain. In such instances, the network can configure the wireless device to perform the RRM measurements of interference in the gap between noncontiguous CCs within the downlink frequency band. The indication can be carried via a system information block (SIB) or via dedicated signaling to the wireless device. Thus, in at least some instances, the RRM measurements at 704 can be performed using the network provided configuration.

As yet a further example, in at least some instances, the network can configure the wireless device to perform RRM measurements of the interference gap. In such instances, the wireless device can then determine whether it can use a single (common) RF chain.

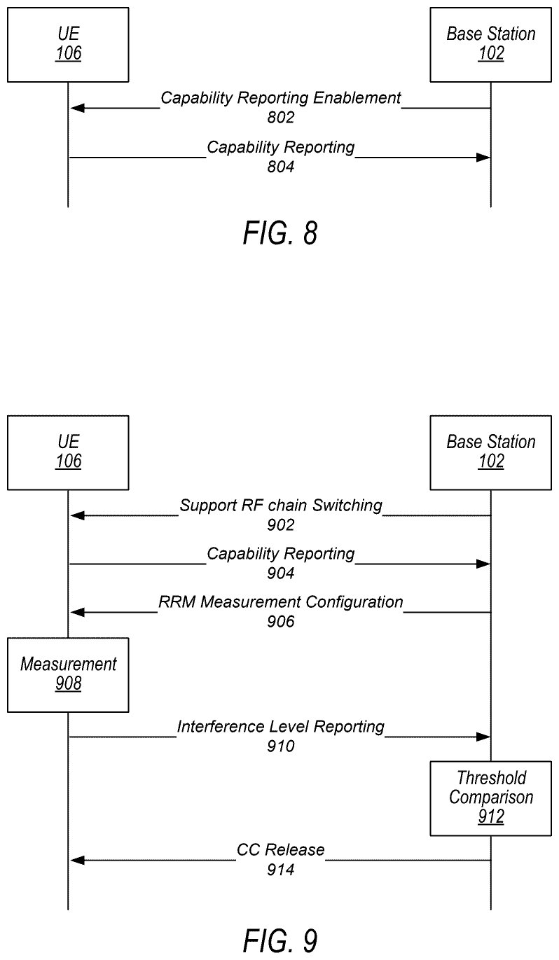

FIG. 8 is a flowchart diagram illustrating an example of signaling for a UE to signal CA capability, at least according to some embodiments.

Aspects of the signaling of FIG. 8 can be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (such as baseband processor 500 illustrated in and described with respect to FIG. 5) and/or other hardware of such a device can be configured to cause the device to perform any combination of the illustrated signaling and/or other signaling.

Note that while at least some signaling of FIG. 8 are described in a manner relating to the use of communication techniques and/or features associated with 3GPP and/or NR specification documents, such description is not intended to be limiting to the disclosure, and aspects of the signaling of FIG. 8 can be used in any suitable wireless communication system, as desired. In various embodiments, some of the signaling shown can be performed concurrently, in a different order than shown, can be substituted for by one or more other signals, and/or can be omitted. Additional signaling can also be performed as desired. As shown, the signaling of FIG. 8 can operate as follows.

The signaling can begin with the wireless device (e.g., UE 106 and/or a baseband processor of UE, such as baseband processor 500) receiving, from a network (e.g., from a base station of the network, such as base station 102 and/or a baseband processor of the base station, such as baseband processor 500), an indication that the network supports the wireless device reporting of a spectrum span (or equivalent spectrum gap) of intra-band non-contiguous CA the wireless device can receive via a single (common) RF chain via capability reporting enablement message 802. The indication can be via a flag (or bit) in a SIB or via a flag (or bit) or field in a capability enquiry message. In response, the wireless device can send/report its spectrum span (or equivalent spectrum gap) of intra-band non-contiguous CA the wireless device can receive via a single (common) RF chain via capability reporting 804. Note that the wireless device can report its spectrum span on a per band basis, at least in some instances. Note that such a reporting scheme can increase a number of bands a wireless device can support as compared to legacy reporting schemes. Note further that if and/or when a spectrum gap between two CC blocks is too large (e.g., larger than a reported value), the network can infer based on the reporting that the wireless device cannot receive the two CCs via a single receive chain and, based on the inference, either only configure one CC block to the wireless device and/or not configure an additional band to the wireless device.

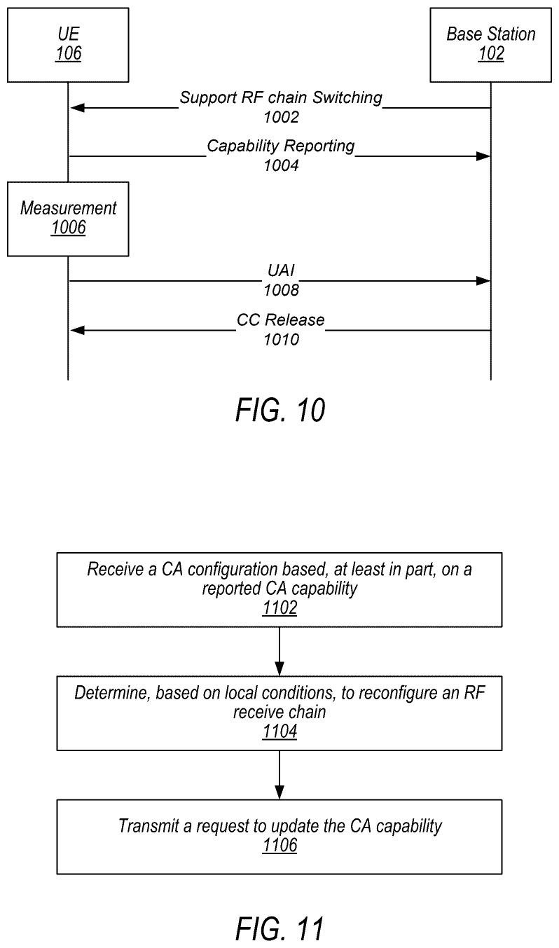

FIGS. 9 and 10 are flowchart diagrams illustrating examples of signaling to support a UE switching between a single RF chain and multiple RF chains, at least according to some embodiments.

Aspects of the signaling of FIGS. 9 and 10 can be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (such as baseband processor 500 illustrated in and described with respect to FIG. 5) and/or other hardware of such a device can be configured to cause the device to perform any combination of the illustrated signaling and/or other signaling.

Note that while at least some signaling of FIGS. 9 and 10 are described in a manner relating to the use of communication techniques and/or features associated with 3GPP and/or NR specification documents, such description is not intended to be limiting to the disclosure, and aspects of the signaling of FIGS. 9 and 10 can be used in any suitable wireless communication system, as desired. In various embodiments, some of the signaling shown can be performed concurrently, in a different order than shown, can be substituted for by one or more other signals, and/or can be omitted. Additional signaling can also be performed as desired. Turning to FIG. 9, as shown, the signaling can operate as follows.

The signaling can begin (e.g., as part of an RRC connection procedure) with the wireless device (e.g., UE 106 and/or a baseband processor of UE, such as baseband processor 500) receiving, from a network (e.g., from a base station of the network, such as base station 102 and/or a baseband processor of the base station, such as baseband processor 500), an indication that the network supports RF chain switching via support RF chain switching message 902. In other words, the network can indicate support for the wireless device reporting an interference level for a gap between CCs in a non-contiguous CA configuration for a frequency band. The indication can be via a SIB or via a capability enquiry message. Upon receiving the indication, the wireless device can report a CA capability with a CC number assuming a single (common) RF chain for receiving non-contiguous CCs within the frequency band via capability reporting 904. The wireless device can then receive an RRM measurement configuration 906 for measuring interference for the gap.

At 908, the wireless device can perform the RRM measurements on the gap. Further, the wireless device can report the measured interference level to the network via interference level reporting 910. At 912, the network can evaluate the interference. For example, the network can compare the interference level to a threshold. The threshold could be specific to the wireless device, e.g., reported to the network as a capability, or could be a fixed value specified via a 3GPP standard. Then, when the interference level exceeds the threshold, the network can release one or more service CCs via CC release message 914.

Turning to FIG. 10, as shown, the signaling can operate as follows.

The signaling can begin (e.g., as part of an RRC connection procedure) with the wireless device (e.g., UE 106 and/or a baseband processor of UE, such as baseband processor 500) receiving, from a network (e.g., from a base station of the network, such as base station 102 and/or a baseband processor of the base station, such as baseband processor 500), an indication that the network supports RF chain switching via support RF chain switching message 1002. In other words, the network can indicate support for the wireless device reporting an interference level for a gap between CCs in a non-contiguous CA configuration for a frequency band. The indication can be via a SIB or via a capability enquiry message. Upon receiving the indication, the wireless device can report a CA capability with a CC number assuming a single (common) RF chain for receiving non-contiguous CCs within the frequency band via capability reporting 1004.

At 1006, the wireless device can perform RRM measurements to determine a level of interference in a gap between non-contiguous CCs within the downlink frequency band. Further, based on the level of interference, the wireless device can determine to reconfigure its radio frequency (RF) chains (e.g., how many receive chains it uses to receive CCs in the downlink frequency band). In response to determining to reconfigure its RF chains, the wireless device send a UAI 1008 requesting release of serving CCs in a non-contiguous CA for a frequency band. In response, the network can release one or more service CCs via CC release message 1010.

Thus, at least according to some embodiments, the signaling of FIGS. 6, 7, 8, 9, and 10 can be used to provide a framework according to which a wireless device can be configured to update CA configurations for fragmented carriers and thus to assist a cellular network to effectively and efficiently schedule and perform wireless communications with the wireless device, at least in some instances.

FIG. 11 is a flowchart diagram illustrating an example of a method for a wireless device to provide an indication to a network of a new supported CA configuration upon changing its radio frequency (RF) chain configuration, at least according to some embodiments.

Aspects of the method of FIG. 11 can be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (such as baseband processor 500 illustrated in and described with respect to FIG. 5) and/or other hardware of such a device can be configured to cause the device to perform any combination of the illustrated method and/or other methods.

Note that while at least some elements of the method of FIG. 11 are described in a manner relating to the use of communication techniques and/or features associated with 3GPP and/or NR specification documents, such description is not intended to be limiting to the disclosure, and aspects of the method of FIG. 11 can be used in any suitable wireless communication system, as desired. In various embodiments, some of the elements of the method shown can be performed concurrently, in a different order than shown, can be substituted for by one or more other elements, and/or can be omitted. Additional elements can also be performed as desired. As shown, the method of FIG. 11 can operate as follows.

At 1102, a wireless device (e.g., UE 106 and/or a baseband processor of UE, such as baseband processor 500) can receive, from a network (e.g., from a base station of the network, such as base station 102 and/or a baseband processor of the base station, such as baseband processor 500), a CA configuration based, at least in part, on a reported CA capability, e.g., a CA capability previously transmitted to the network.

At 1104, the wireless device can determine, based on local conditions, to reconfigure an RF receive chain, e.g., an RF receive chain used to receive one or more component carriers (CCs) associated with the CA configuration.

At 1106, the wireless device can transmit a request to update the CA capability, e.g., based, at least in part, on the determination.

In some instances, the wireless device can receive, from the network, a capability enquiry requesting an update of CA capabilities, e.g., in response to the request to update the CA capability. Additionally, the wireless device can transmit, to the network, an update of CA capabilities in response to the capability enquiry. The update of CA capabilities can be based, at least in part, on the reconfigured RF receive chain.

In some instances, the wireless device can receive, from the network, a configuration for radio resource management (RRM) measurements on a gap between non-contiguous CCs within the CA configuration. In such instances, to determine, based on local conditions, to reconfigure the RF receive chain can include the wireless device performing the RRM measurements on the gap between the non-contiguous CCs. Further, transmission of the request to update the CA capability can be based, at least in part, on the RRM measurements. In some instances, the wireless device can receive, from the network, an indication to use a single RF receive chain to receive non-contiguous CCs in a band within the CA configuration. The indication can be carried in one of a system information block (SIB) or dedicated signaling. In some instances, the indication can explicitly indicate the use of the single RF receive chain. In some instances, the indication can indicate that the non-contiguous CCs are an inter-operator collocated deployment, e.g., and the wireless device can infer, based on the indication, to use the single RF receive chain.

In some instances, the wireless device can transmit, to the network and prior to receiving the CA configuration, a capability report comprising a plurality of supported CA combinations. The plurality of CA combinations can include at least a first set of CCs for a CA band combination that uses a single RF receive chain for receiving the first set of CCs and a second set of CCs for the CA band combination that uses separate RF receive chains for receiving the second set of CCs. In such instances, the first set of CCs can include more CCs than the second set of CCs. Further, the wireless device can perform RRM measurements, determine to reconfigure the RF receive chain based on the RRM measurements, and transmit, to the network, an indication of a selected RF receive chain based on the determination to reconfigure the RF receive chain. In such instances, the indication can be transmitted via radio resource control (RRC) signaling or a medium access control (MAC) control element (CE).

In some instances, the wireless device can receive, from the network and prior to receiving the CA configuration, an indication that the network supports a CA capability indicating a spectrum span of receivable intra-band non-contiguous CA configurations. In addition, the wireless device can transmit, to the network and responsive to the indication, a CA capability indicating one or more spectrum spans of intra-band non-contiguous CA configurations that can be received via a single RF receive chain. The CA configuration can be further based, at least in part, on the one or more spectrum spans of intra-band non-contiguous CA configurations that can be received via a single RF receive chain. Note that the one or more spectrum spans of intra-band non-contiguous CA configurations that can be received via a single RF receive chain can be indicated on a per band basis. Note further that the spectrum span can indicate a maximum spectrum gap between two CCs or two CC blocks that can be included in a CA configuration and remain receivable via the single RF receive chain.

In some instances, the wireless device can receive, from the network and prior to receiving the CA configuration, an indication that the network supports RF chain reconfiguration switching. In addition, the wireless device can transmit, to the network and based, at least in part on the indication, the CA capability. The CA capability can assume an intra-band non-contiguous CA configuration can be received using a single RF receive chain. The indication can be received via a system information block (SIB) or a capability enquiry message. In some instances, the wireless device can receive, from the network and based, at least in part, on the CA capability assuming the intra-band non-contiguous CA configuration can be received using the single RF receive chain, an RRM configuration on a spectrum gap associated with the intra-band non-contiguous CA configuration and report, based on RRM measurements performed based on the RRM configuration, an interference level on the spectrum gap. In such instances, the wireless device can receive, from the network when the reported interference level on the spectrum gap exceeds a threshold, an instruction releasing a CC block within the intra-band non-contiguous CA configuration. In some instances, the wireless device can monitor an interference level on a spectrum gap associated with the intra-band non-contiguous CA configuration and transmit, in response to determining that the interference level exceeds a threshold, a user equipment (UE) Assistance Information (UAI) message requesting release of a CC block within the intra-band non-contiguous CA configuration. In such instances, the wireless device can receive, from the network and based, at least in part, on the UAI message, an instruction releasing a CC block within the intra-band non-contiguous CA configuration. The threshold can be based on a capability of the wireless device (e.g., that can be reported to the network) and/or specified in a standard as an RF requirement.

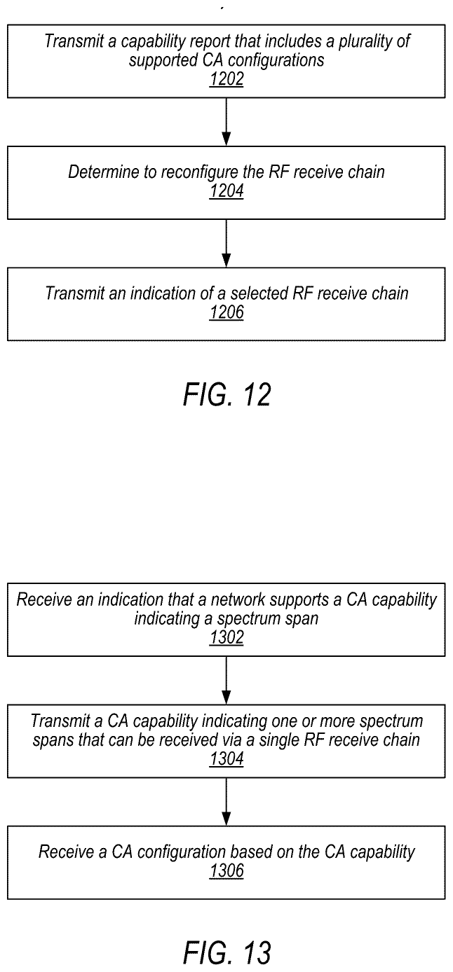

FIG. 12 is a flowchart diagram illustrating an example of a method for a wireless device to provide an indication to a network regarding applicability of a previously reported supported CA configuration upon changing its RF chain configuration, at least according to some embodiments.

Aspects of the method of FIG. 12 can be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (such as baseband processor 500 illustrated in and described with respect to FIG. 5) and/or other hardware of such a device can be configured to cause the device to perform any combination of the illustrated method and/or other methods.

Note that while at least some elements of the method of FIG. 12 are described in a manner relating to the use of communication techniques and/or features associated with 3GPP and/or NR specification documents, such description is not intended to be limiting to the disclosure, and aspects of the method of FIG. 12 can be used in any suitable wireless communication system, as desired. In various embodiments, some of the elements of the method shown can be performed concurrently, in a different order than shown, can be substituted for by one or more other elements, and/or can be omitted. Additional elements can also be performed as desired. As shown, the method of FIG. 12 can operate as follows.

At 1202, a wireless device (e.g., UE 106 and/or a baseband processor of UE, such as baseband processor 500) can transmit, to a network (e.g., from a base station of the network, such as base station 102 and/or a baseband processor of the base station, such as baseband processor 500), a capability report that includes a plurality of supported CA combinations, e.g., prior to receiving a CA configuration. The plurality of CA combinations can include at least a first set of CCs for a CA band combination that uses a single RF receive chain for receiving the first set of CCs and a second set of CCs for the CA band combination that uses separate RF receive chains for receiving the second set of CCs. In such instances, the first set of CCs can include more CCs than the second set of CCs.

At 1204, the wireless device can determine to reconfigure the RF receive chain based, e.g., based on a condition and/or one or more conditions being met.

At 1206, the wireless device can transmit, to the network, an indication of a selected RF receive chain based on the determination to reconfigure the RF receive chain.

In some instances, the wireless device can receive, from the network, the CA configuration, e.g., based on the indication, and determine, based on local conditions (e.g., based on a condition and/or one or more conditions, such as interference levels within a gap between CCs exceeding a threshold), to reconfigure an RF receive chain, e.g., an RF receive chain used to receive one or more component carriers (CCs) associated with the CA configuration. Further, the wireless device can transmit a request to update the CA capability, e.g., based, at least in part, on the determination. In some instances, the wireless device can receive, from the network, a capability enquiry requesting an update of CA capabilities, e.g., in response to the request to update the CA capability. Additionally, the wireless device can transmit, to the network, an update of CA capabilities in response to the capability enquiry. The update of CA capabilities can be based, at least in part, on the reconfigured RF receive chain. In some instances, the wireless device can receive, from the network, a configuration for radio resource management (RRM) measurements on a gap between non-contiguous CCs within the CA configuration. In such instances, to determine, based on local conditions, to reconfigure the RF receive chain can include the wireless device performing the RRM measurements on the gap between the non-contiguous CCs. Further, transmission of the request to update the CA capability can be based, at least in part, on the RRM measurements. In some instances, the wireless device can receive, from the network, an indication to use a single RF receive chain to receive non-contiguous CCs in a band within the CA configuration. The indication can be carried in one of a system information block (SIB) or dedicated signaling. In some instances, the indication can explicitly indicate the use of the single RF receive chain. In some instances, the indication can indicate that the non-contiguous CCs are an inter-operator collocated deployment, e.g., and the wireless device can infer, based on the indication, to use the single RF receive chain.

In some instances, the wireless device can receive, from the network and prior to receiving the CA configuration, an indication that the network supports a CA capability indicating a spectrum span of receivable intra-band non-contiguous CA configurations. In addition, the wireless device can transmit, to the network and responsive to the indication, a CA capability indicating one or more spectrum spans of intra-band non-contiguous CA configurations that can be received via a single RF receive chain. The CA configuration can be further based, at least in part, on the one or more spectrum spans of intra-band non-contiguous CA configurations that can be received via a single RF receive chain. Note that the one or more spectrum spans of intra-band non-contiguous CA configurations that can be received via a single RF receive chain can be indicated on a per band basis. Note further that the spectrum span can indicate a maximum spectrum gap between two CCs or two CC blocks that can be included in a CA configuration and remain receivable via the single RF receive chain.

In some instances, the wireless device can receive, from the network and prior to receiving the CA configuration, an indication that the network supports RF chain reconfiguration switching. In addition, the wireless device can transmit, to the network and based, at least in part on the indication, the CA capability. The CA capability can assume an intra-band non-contiguous CA configuration can be received using a single RF receive chain. The indication can be received via a system information block (SIB) or a capability enquiry message. In some instances, the wireless device can receive, from the network and based, at least in part, on the CA capability assuming the intra-band non-contiguous CA configuration can be received using the single RF receive chain, an RRM configuration on a spectrum gap associated with the intra-band non-contiguous CA configuration and report, based on RRM measurements performed based on the RRM configuration, an interference level on the spectrum gap. In such instances, the wireless device can receive, from the network when the reported interference level on the spectrum gap exceeds a threshold, an instruction releasing a CC block within the intra-band non-contiguous CA configuration. In some instances, the wireless device can monitor an interference level on a spectrum gap associated with the intra-band non-contiguous CA configuration and transmit, in response to determining that the interference level exceeds a threshold, a user equipment (UE) Assistance Information (UAI) message requesting release of a CC block within the intra-band non-contiguous CA configuration. In such instances, the wireless device can receive, from the network and based, at least in part, on the UAI message, an instruction releasing a CC block within the intra-band non-contiguous CA configuration. The threshold can be based on a capability of the wireless device (e.g., that can be reported to the network) and/or specified in a standard as an RF requirement.

FIG. 13 is a flowchart diagram illustrating an example of a method for a wireless device to signal a CA capability, at least according to some embodiments.

Aspects of the method of FIG. 13 can be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (such as baseband processor 500 illustrated in and described with respect to FIG. 5) and/or other hardware of such a device can be configured to cause the device to perform any combination of the illustrated method and/or other methods.

Note that while at least some elements of the method of FIG. 13 are described in a manner relating to the use of communication techniques and/or features associated with 3GPP and/or NR specification documents, such description is not intended to be limiting to the disclosure, and aspects of the method of FIG. 13 can be used in any suitable wireless communication system, as desired. In various embodiments, some of the elements of the method shown can be performed concurrently, in a different order than shown, can be substituted for by one or more other elements, and/or can be omitted. Additional elements can also be performed as desired. As shown, the method of FIG. 13 can operate as follows.

At 1302, a wireless device (e.g., UE 106 and/or a baseband processor of UE, such as baseband processor 500) can receive, from a network (e.g., from a base station of the network, such as base station 102 and/or a baseband processor of the base station, such as baseband processor 500), an indication that the network supports a CA capability indicating a spectrum span of receivable intra-band non-contiguous CA configurations. The indication can be received prior to the wireless device receiving a CA configuration from the network.

At 1304, the wireless device can transmit, to the network and responsive to the indication, a CA capability indicating one or more spectrum spans of intra-band non-contiguous CA configurations that can be received via a single RF receive chain.

At 1306, the wireless device can receive a CA configuration that is based, at least in part, on the one or more spectrum spans of intra-band non-contiguous CA configurations that can be received via a single RF receive chain. Note that the one or more spectrum spans of intra-band non-contiguous CA configurations that can be received via a single RF receive chain can be indicated on a per band basis. Note further that the spectrum span can indicate a maximum spectrum gap between two CCs or two CC blocks that can be included in a CA configuration and remain receivable via the single RF receive chain.

In some instances, the wireless device can receive, from the network, the CA configuration, e.g., based on the indication, and determine, based on local conditions, to reconfigure an RF receive chain, e.g., an RF receive chain used to receive one or more component carriers (CCs) associated with the CA configuration. Further, the wireless device can transmit a request to update the CA capability, e.g., based, at least in part, on the determination. In some instances, the wireless device can receive, from the network, a capability enquiry requesting an update of CA capabilities, e.g., in response to the request to update the CA capability. Additionally, the wireless device can transmit, to the network, an update of CA capabilities in response to the capability enquiry. The update of CA capabilities can be based, at least in part, on the reconfigured RF receive chain. In some instances, the wireless device can receive, from the network, a configuration for radio resource management (RRM) measurements on a gap between non-contiguous CCs within the CA configuration. In such instances, to determine, based on local conditions, to reconfigure the RF receive chain can include the wireless device performing the RRM measurements on the gap between the non-contiguous CCs. Further, transmission of the request to update the CA capability can be based, at least in part, on the RRM measurements. In some instances, the wireless device can receive, from the network, an indication to use a single RF receive chain to receive non-contiguous CCs in a band within the CA configuration. The indication can be carried in one of a system information block (SIB) or dedicated signaling. In some instances, the indication can explicitly indicate the use of the single RF receive chain. In some instances, the indication can indicate that the non-contiguous CCs are an inter-operator collocated deployment, e.g., and the wireless device can infer, based on the indication, to use the single RF receive chain.

In some instances, the wireless device can transmit, to the network and prior to receiving the CA configuration, a capability report comprising a plurality of supported CA combinations. The plurality of CA combinations can include at least a first set of CCs for a CA band combination that uses a single RF receive chain for receiving the first set of CCs and a second set of CCs for the CA band combination that uses separate RF receive chains for receiving the second set of CCs. In such instances, the first set of CCs can include more CCs than the second set of CCs. Further, the wireless device can perform RRM measurements, determine to reconfigure the RF receive chain based on the RRM measurements, and transmit, to the network, an indication of a selected RF receive chain based on the determination to reconfigure the RF receive chain. In such instances, the indication can be transmitted via radio resource control (RRC) signaling or a medium access control (MAC) control element (CE).

In some instances, the wireless device can receive, from the network and prior to receiving the CA configuration, an indication that the network supports RF chain reconfiguration switching. In addition, the wireless device can transmit, to the network and based, at least in part on the indication, the CA capability. The CA capability can assume an intra-band non-contiguous CA configuration can be received using a single RF receive chain. The indication can be received via a system information block (SIB) or a capability enquiry message. In some instances, the wireless device can receive, from the network and based, at least in part, on the CA capability assuming the intra-band non-contiguous CA configuration can be received using the single RF receive chain, an RRM configuration on a spectrum gap associated with the intra-band non-contiguous CA configuration and report, based on RRM measurements performed based on the RRM configuration, an interference level on the spectrum gap. In such instances, the wireless device can receive, from the network when the reported interference level on the spectrum gap exceeds a threshold, an instruction releasing a CC block within the intra-band non-contiguous CA configuration. In some instances, the wireless device can monitor an interference level on a spectrum gap associated with the intra-band non-contiguous CA configuration and transmit, in response to determining that the interference level exceeds a threshold, a user equipment (UE) Assistance Information (UAI) message requesting release of a CC block within the intra-band non-contiguous CA configuration. In such instances, the wireless device can receive, from the network and based, at least in part, on the UAI message, an instruction releasing a CC block within the intra-band non-contiguous CA configuration. The threshold can be based on a capability of the wireless device (e.g., that can be reported to the network) and/or specified in a standard as an RF requirement.

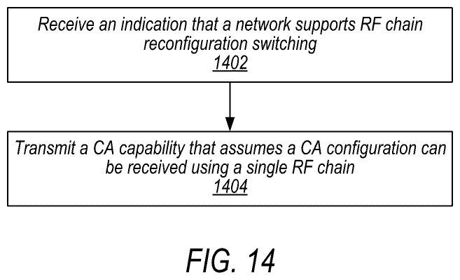

FIG. 14 is a flowchart diagram illustrating an example of a method for a wireless device to switch between a single RF chain and multiple RF chains, at least according to some embodiments.

Aspects of the method of FIG. 14 can be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (such as baseband processor 500 illustrated in and described with respect to FIG. 5) and/or other hardware of such a device can be configured to cause the device to perform any combination of the illustrated method and/or other methods.

Note that while at least some elements of the method of FIG. 14 are described in a manner relating to the use of communication techniques and/or features associated with 3GPP and/or NR specification documents, such description is not intended to be limiting to the disclosure, and aspects of the method of FIG. 14 can be used in any suitable wireless communication system, as desired. In various embodiments, some of the elements of the method shown can be performed concurrently, in a different order than shown, can be substituted for by one or more other elements, and/or can be omitted. Additional elements can also be performed as desired. As shown, the method of FIG. 14 can operate as follows.

At 1402, a wireless device (e.g., UE 106 and/or a baseband processor of UE, such as baseband processor 500) can receive, from a network (e.g., from a base station of the network, such as base station 102 and/or a baseband processor of the base station, such as baseband processor 500), an indication that the network supports RF chain reconfiguration switching. The indication can be received prior to the wireless device receiving a CA configuration. The indication can be received via a system information block (SIB) or a capability enquiry message.

At 1404, the wireless device can transmit, to the network and based, at least in part on the indication, the CA capability. The CA capability can assume an intra-band non-contiguous CA configuration can be received using a single RF receive chain.

In some instances, the wireless device can receive, from the network and based, at least in part, on the CA capability assuming the intra-band non-contiguous CA configuration can be received using the single RF receive chain, an RRM configuration on a spectrum gap associated with the intra-band non-contiguous CA configuration. In addition, the wireless device can report, based on RRM measurements performed based on the RRM configuration, an interference level on the spectrum gap. Further, the wireless device can receive, from the network when the reported interference level on the spectrum gap exceeds a threshold, an instruction releasing a CC block within the intra-band non-contiguous CA configuration. The threshold can be based on a capability of the wireless device (e.g., that can be reported to the network) and/or specified in a standard as an RF requirement.

In some instances, the wireless device can monitor an interference level on a spectrum gap associated with the intra-band non-contiguous CA configuration. In addition, the wireless device can transmit, in response to determining that the interference level exceeds a threshold, a user equipment (UE) Assistance Information (UAI) message requesting release of a CC block within the intra-band non-contiguous CA configuration. Further, the wireless device can receive, from the network and based, at least in part, on the UAI message, an instruction releasing a CC block within the intra-band non-contiguous CA configuration. The threshold can be based on a capability of the wireless device (e.g., that can be reported to the network) and/or specified in a standard as an RF requirement.

In some instances, the wireless device can receive, from the network, the CA configuration, e.g., based on the indication, and determine, based on local conditions, to reconfigure an RF receive chain, e.g., an RF receive chain used to receive one or more component carriers (CCs) associated with the CA configuration. Further, the wireless device can transmit a request to update the CA capability, e.g., based, at least in part, on the determination. In some instances, the wireless device can receive, from the network, a capability enquiry requesting an update of CA capabilities, e.g., in response to the request to update the CA capability. Additionally, the wireless device can transmit, to the network, an update of CA capabilities in response to the capability enquiry. The update of CA capabilities can be based, at least in part, on the reconfigured RF receive chain. In some instances, the wireless device can receive, from the network, a configuration for radio resource management (RRM) measurements on a gap between non-contiguous CCs within the CA configuration. In such instances, to determine, based on local conditions, to reconfigure the RF receive chain can include the wireless device performing the RRM measurements on the gap between the non-contiguous CCs. Further, transmission of the request to update the CA capability can be based, at least in part, on the RRM measurements. In some instances, the wireless device can receive, from the network, an indication to use a single RF receive chain to receive non-contiguous CCs in a band within the CA configuration. The indication can be carried in one of a system information block (SIB) or dedicated signaling. In some instances, the indication can explicitly indicate the use of the single RF receive chain. In some instances, the indication can indicate that the non-contiguous CCs are an inter-operator collocated deployment, e.g., and the wireless device can infer, based on the indication, to use the single RF receive chain.

In some instances, the wireless device can transmit, to the network and prior to receiving the CA configuration, a capability report comprising a plurality of supported CA combinations. The plurality of CA combinations can include at least a first set of CCs for a CA band combination that uses a single RF receive chain for receiving the first set of CCs and a second set of CCs for the CA band combination that uses separate RF receive chains for receiving the second set of CCs. In such instances, the first set of CCs can include more CCs than the second set of CCs. Further, the wireless device can perform RRM measurements, determine to reconfigure the RF receive chain based on the RRM measurements, and transmit, to the network, an indication of a selected RF receive chain based on the determination to reconfigure the RF receive chain. In such instances, the indication can be transmitted via radio resource control (RRC) signaling or a medium access control (MAC) control element (CE). In some instances, the wireless device can receive, from the network and prior to receiving the CA configuration, an indication that the network supports a CA capability indicating a spectrum span of receivable intra-band non-contiguous CA configurations. In addition, the wireless device can transmit, to the network and responsive to the indication, a CA capability indicating one or more spectrum spans of intra-band non-contiguous CA configurations that can be received via a single RF receive chain. The CA configuration can be further based, at least in part, on the one or more spectrum spans of intra-band non-contiguous CA configurations that can be received via a single RF receive chain. Note that the one or more spectrum spans of intra-band non-contiguous CA configurations that can be received via a single RF receive chain can be indicated on a per band basis. Note further that the spectrum span can indicate a maximum spectrum gap between two CCs or two CC blocks that can be included in a CA configuration and remain receivable via the single RF receive chain.

Thus, at least according to some embodiments, the methods of FIGS. 11, 12, 13, and 14 can be used to provide a framework according to which a wireless device can be configured to update CA configurations for fragmented carriers and thus to assist a cellular network to effectively and efficiently schedule and perform wireless communications with the wireless device, at least in some instances.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) cancan be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure cancan be realized in any of various forms. For example, in some embodiments, the present subject matter can be realized as a computer-implemented method, a computer-readable memory medium, or a computer system. In other embodiments, the present subject matter can be realized using one or more custom-designed hardware devices such as ASICs. In other embodiments, the present subject matter can be realized using one or more programmable hardware elements such as FPGAs.

In some embodiments, a non-transitory computer-readable memory medium (e.g., a non-transitory memory element) can be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) can be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
transmitting, to a network, a carrier aggregation (CA) capability of a user equipment (UE);
receiving, from the network, a CA configuration;
determining, based on local conditions, to reconfigure a radio frequency (RF) receive chain; and
transmitting, to the network, a request to update the CA capability.

2. The method of claim 1,
wherein the CA configuration is based, at least in part, on the CA capability transmitted to the network.

3. The method of claim 1, further comprising:
receiving, from the network, a capability enquiry requesting an update of CA capabilities, wherein the capability enquiry is received in response to the request to update the CA capability; and
transmitting, to the network, an update of CA capabilities in response to the capability enquiry.

4. (canceled)

5. The method of claim 3,
wherein the update of CA capabilities is based on the reconfigured RF receive chain.

6. The method of claim 1, further comprising:
receiving, from the network, a configuration for radio resource management (RRM) measurements on a gap between non-contiguous CCs within the CA configuration;
wherein determining, based on local conditions, to reconfigure the RF receive chain includes performing the RRM measurements on the gap between the non-contiguous CCs; and
wherein transmitting the request to update the CA capability is based, at least in part, on the RRM measurements.

7. (canceled)

8. The method of claim 6, further comprising:
receiving, from the network, an indication to use a single RF receive chain to receive non-contiguous component carriers (CCs) in a band, wherein the indication is carried in one of a system information block (SIB) or dedicated signaling.

9. (canceled)

10. The method of claim 8, wherein the indication explicitly indicates one or more of:
the use of the single RF receive chain; or
that the non-contiguous CCs are an inter-operator collocated deployment.

11.-31. (canceled)

32. A baseband processor, comprising:
a memory; and
processing circuitry in communication with the memory and configured to perform operations comprising:
generating instructions to transmit, to a network, a carrier aggregation (CA) capability of a user equipment (UE);
receiving, from the network, a CA configuration;
determining, based on local conditions, to reconfigure a radio frequency (RF) receive chain; and
generating instructions to transmit, to the network, a request to update the CA capability.

33. The baseband processor of claim 32,
wherein the processing circuitry is further configured to perform operations comprising:
generating instructions to transmit, to the network and prior to receiving the CA configuration, a capability report comprising a plurality of supported CA combinations.

34. The baseband processor of claim 33,
wherein the plurality of CA combinations includes at least a first set of CCs for a CA band combination that uses a single radio frequency (RF) receive chain for receiving the first set of CCs and a second set of CCs for the CA band combination that uses separate RF receive chains for receiving the second set of CCs.

35. The baseband processor of claim 33,
wherein the processing circuitry is further configured to perform operations comprising:
performing radio resource management (RRM) measurements;
determining to reconfigure the RF receive chain based on the RRM measurements; and
generating instructions to transmit, to the network, an indication of a selected RF receive chain based on the determination to reconfigure the RF receive chain, wherein the indication is transmitted via radio resource control (RRC) signaling or a medium access control (MAC) control element (CE).

36. The baseband processor of claim 32,
wherein the processing circuitry is further configured to perform operations comprising:
receiving, from the network and prior to receiving the CA configuration, an indication that the network supports a CA capability indicating a spectrum span of receivable intra-band non-contiguous CA configurations; and
generating instructions to transmit, to the network and responsive to the indication, a CA capability indicating one or more spectrum spans of intra-band non-contiguous CA configurations that can be received via a single RF receive chain, wherein the CA configuration is further based, at least in part, on the one or more spectrum spans of intra-band non-contiguous CA configurations that can be received via a single RF receive chain.

37. The baseband processor of claim 36,
wherein the one or more spectrum spans of intra-band non-contiguous CA configurations that can be received via a single RF receive chain are indicated on a per band basis.

38. The baseband processor of claim 36,
wherein the spectrum span indicates a maximum spectrum gap between two component carriers (CCs) or two CC blocks that can be included in a CA configuration and remain receivable via the single RF receive chain.

39. A wireless device, comprising:
one or more antennas; and
a baseband processor in communication with the one or more antennas and configured to cause the wireless device to perform operations comprising:
transmitting, to a network, a carrier aggregation (CA) capability of a user equipment (UE);
receiving, from the network, a CA configuration;
determining, based on local conditions, to reconfigure a radio frequency (RF) receive chain; and
transmitting, to the network, a request to update the CA capability.

40. The wireless device of claim 39,
wherein the baseband processor is further configured to cause the wireless device to perform operations comprising:
receiving, from the network and prior to receiving the CA configuration, an indication that the network supports RF chain reconfiguration switching, wherein the indication is received via a system information block (SIB) or a capability enquiry message; and
transmitting, to the network and based, at least in part on the indication, the CA capability, wherein the CA capability assumes an intra-band non-contiguous CA configuration can be received using a single RF receive chain.

41. The wireless device of claim 40,
wherein the baseband processor is further configured to cause the wireless device to perform operations comprising:
receiving, from the network and based, at least in part, on the CA capability assuming the intra-band non-contiguous CA configuration can be received using the single RF receive chain, a radio resource management (RRM) configuration on a spectrum gap associated with the intra-band non-contiguous CA configuration; and
reporting, based on RRM measurements performed based on the RRM configuration, an interference level on the spectrum gap.

42. The wireless device of claim 41,
wherein the baseband processor is further configured to cause the wireless device to perform operations comprising:
receiving, from the network when the reported interference level on the spectrum gap exceeds a threshold, an instruction releasing a CC block within the intra-band non-contiguous CA configuration, wherein the threshold is based on a reported capability or specified in a standard as an RF requirement.

43. The wireless device of claim 40,
wherein the baseband processor is further configured to cause the wireless device to perform operations comprising:
monitoring an interference level on a spectrum gap associated with the intra-band non-contiguous CA configuration; and
transmitting, in response to determining that the interference level exceeds a threshold, a user equipment (UE) Assistance Information (UAI) message requesting release of a CC block within the intra-band non-contiguous CA configuration.

44. The wireless device of claim 43,
wherein the baseband processor is further configured to cause the wireless device to perform operations comprising:
receiving, from the network and based, at least in part, on the UAI message, an instruction releasing a CC block within the intra-band non-contiguous CA configuration.
